(19) United States
(12) Patent Application Publication
(10) Pub. No.: US 2026/0307356 A1
(43) Pub. Date: Oct. 8, 2026

(54) PRESS MACHINE AND METHOD FOR PRODUCING MULTI-LAYER PRODUCTS

(71) Applicant: AUTOMATIC LAMINATION TECHNOLOGIES S.R.L., CARONNO VARESINO (VA) (IT)

(72) Inventors: GIOVANNI LUCA SABATINO, GORLA MINORE (VARESE) (IT); FRANCESCO PARRINELLO, SUMIRAGO (VARESE) (IT)

(21) Appl. No.: 19/482,107

(22) PCT Filed: May 9, 2023
(86) PCT No.: PCT/IT2023/000015

§ 371 Date: Nov. 6, 2025

(51) Int. Cl. B30B 5/02; B30B 15/00; B30B 15/06; B30B 15/30

(52) U.S. Cl. CPC B30B 5/02; B30B 15/0094; B30B 15/061; B30B 15/30

(57) ABSTRACT

A press machine for producing multi-layer products including feed means, plane operation means and a pressure regulator. The feed means are configured to introduce a base product and one or more films into a workstation. The plane operation means, active in the workstation, are configured to exert a force on the base product and on one or more films to produce multi-layer products. The pressure regulator, associated to the plane operation means, is configured to set the force exerted by the plane operation means. The plane operation means are also configured to exert a time-varying force that can be modulated by the pressure regulator.

### CROSS-REFERENCE TO RELATED APPLICATIONS

This application is a national stage entry of PCT/IT2023/000015, filed on May 9, 2023, the entire disclosure of which is incorporated herein by reference.

### BACKGROUND OF THE INVENTION

The object of the present invention is a press machine which may be used for coupling materials and/or semi-finished products in sheet or foil form or more generally in “thin film” form (such as thin metal or polymer foils with one or more protective surface films) and which may be used in various manufacturing applications such as-but not limited to-the production of printed circuit boards or made by electro-or photochemical etching; in addition, the object of the present invention is a method for producing multi-layer products made from semi-finished sheet (or foil) products.

The concerned machine is inserted or may be inserted in a line of machines defined as “Dual Stage Lamination”, where Dual Stage Lamination refers to a production process that takes place in two steps.

Generally, each of the two steps is managed by one of the following machines:
A so-called “vacuum laminator” (known in the technical jargon as “MVC”); and
A so-called “planarization press” (known in the technical jargon as “Flat Press”).

Various types of assembly are known in the field of the so-called laminating machines capable of operating on planar foil or otherwise “laminar” semi-finished products: for example, it is known from EP2749412 a method for laminating substrates including the steps of disposing a pressure-sensitive adhesive layer between a substantially planar surface of a first substrate and a substantially planar surface of a second substrate, disposing the first substrate, the pressure-sensitive adhesive layer, and the second substrate within a vacuum chamber, evacuating the vacuum chamber, and applying a pressure to at least one of the first substrate and the second substrate.

It is also known from US2018/201007 a vacuum system for film lamination, including a vacuum chamber module, a film-pressing module, a substrate susceptor module and a hot-plate heating module: in this system, the film-pressing module includes a film-pressing platen, and the substrate susceptor module includes a substrate susceptor supported by a spring-loaded mechanism. During a film-lamination process, the film-pressing platen is actuated to move downwards to attach a laminating film onto a substrate, and the substrate susceptor is actuated to move downwards and finally rest on the hot-plate heating module, and successively an adhesive glue disposed between the laminating film and the substrate can be thermally cured. After completing the film-lamination process, the film-pressing platen is actuated upwards so that the substrate susceptor also is actuated to move upwards to its initial position by a restoring force exerted by the spring-loaded mechanism (so that the laminating film can be properly bonded to the substrate to avoid lamination defects such as air bubbles and to improve adhesion strength)

Last but not least, it is known from US2005/173063 a laminating apparatus including conveyor rollers which convey a carrier tape in a longitudinal direction, heating/pressing rollers which heat the carrier tape conveyed by the conveyor rollers on roller surfaces, and a convey path changing roller which adjusts contact areas in which the carrier tape comes into contact with the roller surfaces of the heating/pressing rollers.

Usually, such technologies are based on appropriate modes of advancing and retaining a “base” laminar element, which must be coupled, on just one of its faces or on both of them (depending on the requirements), with a very thin film or cover strip.

In this step of the cycle, the objective is to make a film adhere to a given semi-finished product.

The goodness of this process is assessed primarily through the level of conformation and adhesion of the film to the semi-finished product or its possible lithography.

The problems that arise during the process are related to the fact that the film is applied to mostly rough surfaces with raised channels or patterns or depressions.

Disadvantageously, it is difficult to implement a process that can enable to achieve an adequate level of goodness, and thus avoid bubbles or wrinkles between the semi-finished product and the film once assembled.

Currently, the prior art solves the problems related to conformation and adhesion between the semi-finished product and the film by applying a constant force to the multi-layer product.

Disadvantageously, especially with regard to electrical circuits, a good conformation of the applied film is not sufficient, but it is also necessary to obtain an excellent flatness of the boards once the process is complete.

In fact, the semi-finished product-polymer complex is not perfectly flat after vacuum-lamination, as the sole objective of this step is that the applied film follows the conformation of the pattern on the semi-finished product.

The second step of the current process therefore focuses exclusively on making the semi-finished product-film complex perfectly smooth and flat by pressing it with rectified steel plates.

Such planarization presses traditionally allow to set a target pressure to be reached (such pressure may be expressed as the ratio of a given force imposed by an appropriate machine or actuator on a pressing area), and typically the machines currently on the market constantly compress the semi-finished product-film complex with a nominal force required to achieve the target pressure over the entire complex area.

However, in the early steps of the approach between the machine and the complex, the contact area between the two is very small, as only the higher reliefs are subjected to pressure: the nominal force is therefore not evenly distributed over the complex but is concentrated on small areas of the latter, resulting in a very high specific pressure in the first moments of the machine use.

As the planarization presses close, and as time goes by, the contact area increases and the pressure decreases until the set target pressure is reached: disadvantageously, the initial pressure peaks cause the so-called squeezing phenomenon and/or damages to possible electronic circuits within the semi-finished product-film complex.

### BRIEF SUMMARY OF THE INVENTION

The technical task of the present invention is therefore to make available a press machine and a related method for producing multi-layer products that overcomes the drawbacks of the aforementioned prior art.

The object of the present invention is therefore to make available a press machine and a method for producing multi-layers that enable to achieve optimum flatness.

A further object of the present solution is therefore to make available a press machine and a method for producing multi-layers that avoid possible damage to the final product.

Finally, a further object of the present invention is to make available a press machine and a method for producing multi-layers that are versatile in order to cover multiple production lines.

The defined technical task and the specified objects are substantially achieved by a press machine comprising the technical characteristics set forth in one or more of the appended claims. The dependent claims may correspond to possible embodiments of the invention.

According to the present invention, a press machine is shown for producing multi-layer products comprising feed means configured to introduce a base product and one or more films to be placed on the base product into a workstation.

The press machine comprises plane operation means, active in the workstation, configured to exert a force on the base product and on one or more films to produce multi-layer products.

The plane operation means are configured to exert a time-varying force.

The machine comprises a pressure regulator associated with the plane operation means configured to set the force exerted by the operation means.

The pressure regulator is configured to modulate the time-varying force.

Advantageously, the pressure regulator in combination with the plane operation means allow to obtain products with a high level of goodness.

The high level of goodness is guaranteed by certain final parameters of the multi-layer product, such as conformation, adhesion between the base product and one or more films, and the flatness of the multi-layer product.

Furthermore, the present invention makes available a method for producing multi-layer products.

The method for producing multi-layer products includes the step of feeding a base product into a workstation and then feeding and placing one or more films on the base product.

The method also includes the step of modulating a time-varying force through a pressure regulator and exerting the time-varying force on the base product and on one or more films in order to make a multi-layer product.

Further features and advantages of the present invention will become clearer from the indicative, and therefore non-limiting, description of a press machine and a related method for producing multi-layer products.

### BRIEF DESCRIPTION OF THE DRAWINGS

Such a description will be set forth herein below with reference to the accompanying drawings, provided for merely indicative and therefore non-limiting purposes, wherein:

FIGS. 1A, 1B and 1C are schematic representations of a possible embodiment of a press machine for producing multi-layer products at different time instants.

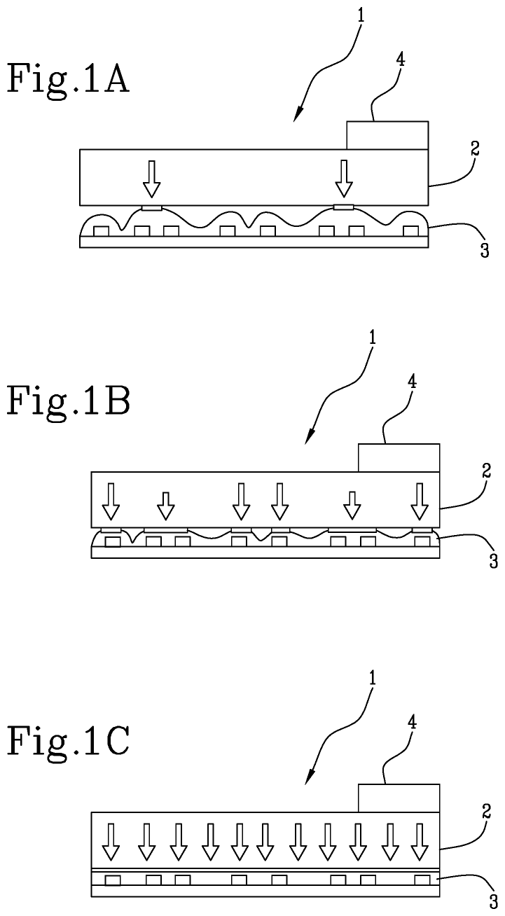

### DESCRIPTION OF EXAMPLE EMBODIMENTS

With reference to the attached figures, 1 globally denotes a press machine for producing multi-layer products 3, which, for ease of description, will be hereinafter referred to as press machine 1.

The press machine 1 basically comprises feed means, plane operation means 2 and a pressure regulator 4.

The feed means are configured to introduce into a workstation a base product and one or more films to be placed/coupled onto the base product. The base products used may be boards or panels comprising electronic circuits and therefore characterised by a particular pattern conformation (as well as having variations, even of a “micrometric” level, in the height or thickness in their plan development).

The surface pattern of the base products may have raised ridges or depressed channels.

The films that are made to adhere onto the base product may be, for example, photosensitive polymer films.

According to a possible embodiment, there may be an adhesive between the base product and one or more films.

In other words, 3 dielectric sheets containing hot glue may be used within the multi-layer product, which, once hot-pressed, allow the adhesive to flow into the circuit of the base product.

The plane operation means 2, active in the workstation, are configured to exert a force on the base product and on one or more films to produce multi-layer products 3.

Specifically, the plane operation means 2 are configured to exert a time-varying force.

In other words, the plane operation means 2 compress the multi-layer product 3 with a time-varying force reaching a limit pressure.

Advantageously, the force applied on the multi-layer product 3 by the plane operation means 2 will increase or decrease over time depending on whether the contact area between the multi-layer product 3 and the plane operation means 2 increases or decreases, ensuring that a limit pressure is achieved and maintained.

In other words, as the contact area increases, due to the progressive compression of the ridges characterising the pattern of the product, the pressing force is adjusted accordingly, thus ensuring the balance of the limit pressure.

Advantageously, the plane operation means 2 ensure a proper conformation and adhesion of the film to the base product or to its possible lithography, even in case the base product is not smooth but “rough” (meaning a base product whose surface roughness or “height distribution” in its lying plane is not even but is subject to variations, even of a “micrometric” nature, such as caused by the presence of conductive tracks obtained on a base substrate of the base product itself) and/or with raised or depressed channels and/or patterns.

According to a possible embodiment, at least one of the plane operation means 2 is a vacuum laminator comprising at least one vacuum chamber.

Advantageously, the vacuum chamber prevents bubbles from forming between the base product and one or more films placed on top of it.

The laminator, by means of a combination of force-temperature-vacuum, pursues the objective of making one or more films adhere to the top of the base product.

Advantageously, the temperature activates, when present, the adhesive between the base product and one or more films, ensuring a solid adhesion between the various layers within the multi-layer product 3.

According to a possible embodiment, at least one of the plane operation means 2 is a planarization press comprising rectifying sensors connected to the pressure regulator 4.

Advantageously, the planarization press compresses the multi-layer product 3, making it perfectly smooth and flat.

Thanks to the flat surface of the planarization press and the temperature applied to the plane operation means 2, the adhesive between the base product and one or more films is evenly distributed within the multi-layer product 3.

Advantageously, the planarization press enables to produce even and shiny multi-layer products 3.

Preferably, the plane operation means 2 comprise a yielding membrane.

The yielding membrane is configured to expand on the multi-layer product 3 while the latter id being produced.

Advantageously, the yielding membrane of the plane operation means 2 ensures a proper conformation of the multi-layer product 3 by expanding in every roughness and compressing one or more films against the base product.

The pressure regulator 4 associated or associable with the plane operation means 2 is configured to set the force exerted by the plane operation means 2.

The pressure regulator 4 is configured to modulate the time-varying force exerted by the plane operation means 2.

According to a possible embodiment, the pressure regulator 4 is configured to modulate and set the time-varying force by defining force ramps at different time intervals.

In other words, by means of the pressure regulator 4, which defines force ramps at different time intervals, it is possible to achieve a ration uniformity between a function curve of the applied pressure and a function curve of the amount of area in contact between the multi-layer product 3 and the plane operation means 2.

Advantageously, the ratio uniformity of the pressure curves and contact area eases the adhesive to flow and reduces leakage of the adhesive from the edges of the base product and possible damages to electrical circuits.

Preferably, the pressure regulator 4 is configured to set and modulate the variable force so as to identify a limit value of a force ramp at each time interval.

According to a possible embodiment, the pressure regulator 4 is configured to identify a limit duration of a time interval depending on a predetermined force ramp.

According to another possible embodiment of the press machine 1, the pressure regulator 4 includes or defines a database.

The database may comprise one or more limit values of a force ramp and/or a limit duration of a time interval for each multi-layer product 3.

Preferably, the pressure regulator 4 comprises a pressure sensor configured to measure a variation in pressure on multi-layer products 3 as the time-varying force changes.

According to a possible embodiment, the pressure regulator 4 also comprises a database containing one or more limit pressure values.

The limit pressure values are associated or associable with predetermined expected results.

The pressure controller 4 is also configured to compare the measured pressure variation with one or more limit pressure values and modulate the time-varying force according to the comparison to obtain a certain expected result.

Preferably, the pressure controller 4 comprises a database with one or more rectifying threshold values.

According to this possible embodiment, the pressure regulator 4 is configured to compare the rectifying threshold values with one or more values measured by the rectifying sensor of the planarization press.

In a possible embodiment, the pressure controller 4 is configured to set and modulate a temperature parameter internal to the plane operation means 2.

Preferably, the pressure controller 4 comprises a contact sensor capable of calculating in advance the contact area between the multi-layer product 3 and the plane operation means 2.

The contact sensor, according to a possible embodiment not shown in the figures, comprises a radar system.

The present invention also makes available a method for producing multi-layer products 3 by means of a press machine 1.

The method provides essential steps for producing multi-layer products 3, and other possible optional steps, which may provide additional aspects or alternatives for implementing the production method.

The method for producing multi-layer products 3 essentially includes four steps.

The step of feeding a product into a workstation.

The step of feeding one or more films into the workstation by placing them on the base product.

The step of modulating a time-varying force through a pressure regulator 4.

The step of exerting by means of plane operation means 2 the time-varying force on the base product and on one or more films so as to make the multi-layer product 3.

Preferably, the method optionally comprises the step of setting temperature and/or force and/or vacuum parameters of the plane operation means 2.

This is followed by the step of maintaining the parameters just mentioned, until the multi-layer product 3 is obtained.

According to an aspect of the present invention, the method comprises the step of defining a vacuum within the plane operation means 2 and on the multi-layer product 3.

The vacuum is maintained within the plane operation means 2 during the step of exerting the time-varying force on the multi-layer product 3.

Advantageously, the vacuum step enables to remove the air trapped within the plane operation means 2 and/or in the multi-layer product 3.

The method comprises, during the step of exerting a time-varying force, a step of defining a limit operating pressure and a subsequent step of gradually reducing the limit operating pressure.

The step of defining the limit pressure takes place while maintaining the vacuum within the plane operation means 2.

The step of defining the limit pressure takes place by introducing high pressure above the surface of the multi-layer product 3.

During this step, it is possible to modulate, by means of the pressure regulator 4, the pressure applied over time.

According to an aspect of the present invention, the method also comprises a step of programming force ramps adapted to define, at different time intervals, the time-varying force.

The step of programming ramps may provide to apply gradual steps of increasing or decreasing force ramps as a function of an increase or decrease in a contact area between the multi-layer product 3 and the plane operation means 2 in a given time interval.

Advantageously, the application of gradual steps of force ramps, in particular the gradual decrease in pressure, allows any adhesive contained within the multi-layer product 3 to drain off evenly.

Next, according to a possible aspect of the invention, follows the removal of the high pressure applied above the surface of the multi-layer product 3 so that, thanks to the step of maintaining the vacuum, the product settles into a rest position.

Preferably, the method comprises a step of removing vacuum on the multi-layer product 3: by removing the vacuum, high pressure is then applied again within the plane operation means 2.

Advantageously, the absence of vacuum and the application of high pressure creates a thrust adapted to conform the multi-layer product 3.

In other words, the conformation of the multi-layer product 3 is no longer given only by the plane operation means 2, and in particular by the yielding membrane, but by the air that is free to reach any point on the surface of multi-layer product 3.

Advantageously, the present invention makes available a press machine 1 for producing multi-layer products 3 and a method for producing multi-layer products 3 capable of overcoming the drawbacks of the prior art.

Advantageously, the present invention makes it possible to achieve an excellent flatness, thus guaranteeing a reduction in possible damages to the final product and, as a further consequence, a greater flexibility in order to cover more production lines.

1. A press machine for producing multi-layer products comprising:
feed means configured to introduce a base product and one or more films to be placed on said base product into a workstation;
plane operation means, active in said workstation, configured to exert a force on said base product and said one or more films to produce multi-layer products; and
a pressure regulator associated with said plane operation means configured to set said force exerted by said operation means,
wherein said plane operation means being configured to exert a time-varying force and in that said pressure regulator is configured to modulate said time-varying force,
wherein:
said pressure regulator (4) is configured to modulate and set said time-varying force by defining force ramps at different time intervals; and
said pressure regulator (4) is configured to set and modulate said variable force so as to identify a limit value of a force ramp at each time interval.

2-3. (canceled)

4. The press machine according to claim 1, wherein said pressure regulator is configured to identify a limit duration of a time interval depending on a predetermined force ramp.

5. The press machine according to claim 1, wherein said pressure regulator comprises or defines a database comprising one or more limit values of a force ramp and/or a limit duration of a time interval for each multi-layer product.

6. The press machine according to claim 1, wherein said pressure regulator comprises a pressure sensor configured to measure a pressure variation on said multi-layer products as the time-varying force changes.

7. The press machine according to claim 6, wherein said pressure regulator comprises a database containing one or more limit pressure values, associated or associable to predetermined expected results; said pressure regulator being further configured to compare said measured pressure variation with said one or more limit pressure values and to modulate said time-varying force according to said comparison to obtain a given expected result.

8. The press machine according to claim 1, wherein said pressure regulator is configured to set and modulate a temperature parameter internal to said plane operation means.

9. The press machine according to claim 1, wherein at least one of said plane operation means is a vacuum laminator comprising at least one vacuum chamber.

10. The press machine according claim 1, wherein at least one of said plane operation means is a planarization press comprising rectifying sensors connected to said regulator.

11. The press machine according to claim 1, wherein said plane operation means comprise a yielding membrane, said yielding membrane is configured to expand on said multi-layer product during said production of said multi-layer product.

12. A method for producing multi-layer products, in a press machine according to claim 1, comprising the steps of:
feeding a base product into a workstation;
feeding one or more films into said workstation by placing them on said base product;
modulating a time-varying force through a pressure regulator;
exerting by means of plane operation means said time-varying force on said base product and said one or more films so as to make said multi-layer product.

13. The method according to claim 12, further comprising the steps of:
setting temperature and/or force and/or vacuum parameters of said plane operation means;
maintaining said parameters until the multi-layer product is obtained.

14. The method according to claim 12, comprising the step of:
defining a vacuum within said plane operation means and on said multi-layer product;
maintaining said vacuum within said plane operation means during said step of exerting the time-varying force on said multi-layer product.

15. The method according to claim 12, comprising, during said step of exerting the time-varying force, a step of defining a limit operating pressure and a subsequent step of gradually reducing said limit operating pressure.

16. The method according to claim 14, comprising a step of removing vacuum on the multi-layer product.

17. The method according to claim 12, comprising a step of programming force ramps adapted to define, at different time intervals, said time-varying force.

18. The method according to claim 17, wherein said step of programming force ramps provides to apply gradual steps of increasing or decreasing force ramps according to an increase or decrease in a contact area between said multi-layer product and said plane operation means in a given time interval.
